(19) United States
(12) Patent Application Publication
(10) Pub. No.: US 2023/0115157 A1
(43) Pub. Date: Apr. 13, 2023

(54) SYSTEM AND METHOD FOR CONDUCTING A LOTTERY-STYLE BINGO GAME WITH SELECTIVE PLAYER INPUT

(71) Applicants: Robert Williams, Sliema (MT); Russell Morin, Bennington, NE (US)

(72) Inventors: Robert Williams, Sliema (MT); Russell Morin, Bennington, NE (US)

(21) Appl. No.: 17/804,276

(22) Filed: May 26, 2022

Related U.S. Application Data
(60) Provisional application No. 63/202,122, filed on May 27, 2021.

(51) Int. Cl. G07F 17/32

(52) U.S. Cl. CPC G07F 17/329; G07F 17/3262

(57) ABSTRACT

Systems and methods for conducting a bingo-style game with player interaction. Once a winning bingo pattern is pre-determined, players select bingo numbers equal to the number of spaces required to achieve the winning pattern. The system randomly assigns the player-selected bingo numbers to the spaces forming the winning pattern. The system then randomly selects and assigns bingo numbers to the spaces not forming part of the winning pattern. Upon generating each bingo card comprising the player-selected numbers and system-selected numbers, the system compares the prospective bingo card to all previously generated bingo cards to confirm no identical matches. If a match does exist, the system generates a new bingo card such that the issued bingo card does not match any previously generated bingo cards. Various levels of prizes are created and awarded based on a number of bingo ball calls needed for a first player to achieve the winning pattern.

### CROSS-REFERENCES

This application claims priority to U.S. Patent Application No. 63/202,122 filed May 27, 2021, and which is incorporated herein for all purposes.

### FIELD

The embodiments of the present invention relate to a gaming system and method involving a processor, bingo balls and bingo cards.

### BACKGROUND

The rules of bingo are relatively simple. Players buy bingo cards that are numbered from 1 to 75 in America and 1 to 90 in Europe. In America, each bingo card contains 24 numbers and a blank square, situated on a 5 by 5 grid. The columns are labeled “B” (numbers 1-15), “I” (numbers 16-30), “N” (numbers 31-45), “G” (numbers 46-60), and “O” (numbers 61-75). When a bingo game starts, random numbers are drawn and the player holding the bingo card that first completes a predefined bingo pattern wins the bingo game and associated prize. A predefined bingo pattern typically consists of a line formed of five numbers in a diagonal, horizontal or vertical row. Many other bingo patterns are well known.

It would be advantageous to develop new bingo game systems with large prizes and player pools.

### SUMMARY

The embodiments of the present invention relate to a system and method for conducting a bingo game that generates lottery-style prizing and enables an unlimited number of players in an unlimited number of locations to play against one another. The systems and methods also facilitate massive jackpots attracting players.

According to the embodiments of the present invention, players select numbers which are uniquely configured by the system so that each player can play their own chosen bingo numbers, in games which are determined by the first player to achieve the game's required game ending pattern that is contains each player's chosen bingo numbers. The system uses a methodology for generating unique bingo cards for each player based upon the numbers that each of the players have chosen and the bingo cards which have previously been distributed for each game. In addition, the methodology for establishing the winner(s) and the math models that establish the payouts are all unique to the invention.

Unlike traditional bingo, but more akin to Upick'em bingo games, a game that is similar to Keno but is recognized in most U.S. jurisdictions as bingo, or to a lottery, players pick their own subset of numbers that appear on the in the game's winning bingo pattern on their bingo card(s). The methodology for selecting the numbers, where the numbers appear on the player's bingo card(s), and the mechanical process used to generate the unique bingo cards are each unique to the embodiments of the present invention.

In one embodiment, the bingo games facilitated by the embodiments of the present invention are played in two tiers. Players begin the bingo game by playing against only one other player in a first bingo game. The pay table that each of the matched players is playing, which is determined by the initial wager or bet by each player, determines whether a player is also qualified to play again by joining a number of other players in the “main” bingo game. With this embodiment, the bingo game can be played and enjoyed both immediately against a single player for smaller prizes and thereafter against a large pool of players with larger prizes. With the large pool of players, jackpot prizes can reach amounts associated with typical lottery prizes and be won by achieving the game ending bingo pattern. Within both bingo games pre-established prizes contained in the game rules are ultimately awarded to the winning player based upon being the first player to achieve the wining bingo pattern and by the pre-established number of ball calls that it takes to achieve the winning bingo pattern announced before the start of the game.

Other variations, embodiments and features of the present invention will become evident from the following detailed description, drawings and claims.

### BRIEF DESCRIPTION OF THE DRAWINGS

FIG. 1 illustrates a conventional bingo card format (5×5 matrix) without bingo numbers printed thereon whereby this card design is typically played using 75 balls;

FIG. 2 illustrates an alternative bingo card format (3×9 matrix) without bingo numbers printed thereon whereby this card design is typically played using 90 balls;

FIG. 3 illustrates an exemplary depiction of bingo winning patterns that may be formed using a 5×5 matrix bingo card;

FIG. 4 illustrates a table of 75 possible bingo numbers used with a conventional 5×5 matrix bingo card;

FIG. 5 illustrates an exemplary pre-established winning bingo pattern in the form of an X;

FIG. 6 illustrates a player-selected numbers being randomly assigned by the system into the X-shaped winning bingo pattern on a bingo card according to the embodiments of the present invention;

FIG. 7 illustrates the bingo card from FIG. 6 with numbers being randomly selected and positioned by the system on the spaces not forming part of the X-shaped bingo pattern according to the embodiments of the present invention;

FIG. 8 illustrates the bingo card from FIGS. 6 and 7 with all numbers (player-selected and system-selected) depicted according to the embodiments of the present invention;

FIGS. 9A and 9B illustrate illustrates an exemplary probability and payout tables according to the embodiments of the present invention;

FIG. 10 illustrates a flow chart detailing a methodology of conducting a bingo game according to the embodiments of the present invention;

FIG. 11 illustrates a schematic showing an exemplary system according to the embodiments of the present invention; and

FIG. 12 illustrates a schematic showing an alternative system according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a computer should be understood to be any one of a general purpose computer, as for example a personal computer or a laptop computer, a client computer configured for interaction with a server, a special purpose computer such as a server, or a smart phone, soft phone, tablet computer, personal digital assistant or any other machine adapted for executing programmable instructions in accordance with the description thereof set forth above.

The embodiments of the pre4sent invention are based on the game of bingo which generally includes a bingo card depicting spaces and numbers (or other symbols) and a random number (or other symbols) generator. In the most well-known bingo game, the bingo game comprises a bingo card depicting a 5×5 matrix of spaces filled with unique, random numbers (except for the center square which is marked or otherwise identified as a free space) selected from numbers 1-75 and a bingo ball blower configured to actively mix 75 bingo balls marked 1-75 and intermittently select the bingo balls until one or more persons announce bingo responsive to obtaining and marking the winning bingo pattern on their bingo card. With conventional bingo, the columns are identified as a “B” column, “I” column, “N” column, “G: column and “I” column and each column only includes a range of the 75 bingo numbers, namely the “B” column includes numbers 1-15, “I” column includes numbers 16-30, “N” column includes numbers 31-45, “G” column includes numbers 46-60, and “O” column includes numbers 61-75. Bingo is most-often played for money and other prizes.

While the detailed description focuses on a conventional bingo card and game, those skilled in the art will recognize that the embodiments of the present invention may be used with any card/substrate (virtual or physical) depicting an arrangement of numbers and/or symbols from which one or more winning patterns may be generated and means for generating/selecting/drawing random numbers and/or symbols from a pool of such numbers and/or symbols. The embodiments of the present invention may be played with conventional physical bingo cards or virtual bingo cards displayed on a game screen and physical random number generator (e.g., ball blower) or software-based random number generator. As used herein, bingo refers to any game having m (rows)×n (columns) matrix arrangements of numbers and/or symbols forming two or more physical or virtual cards after which random numbers and/or symbols are selected from a pool of numbers and/or symbols such that the physical or virtual cards may be marked with matches until one or more of the unique bingo cards depict a pre-established winning pattern of markings.

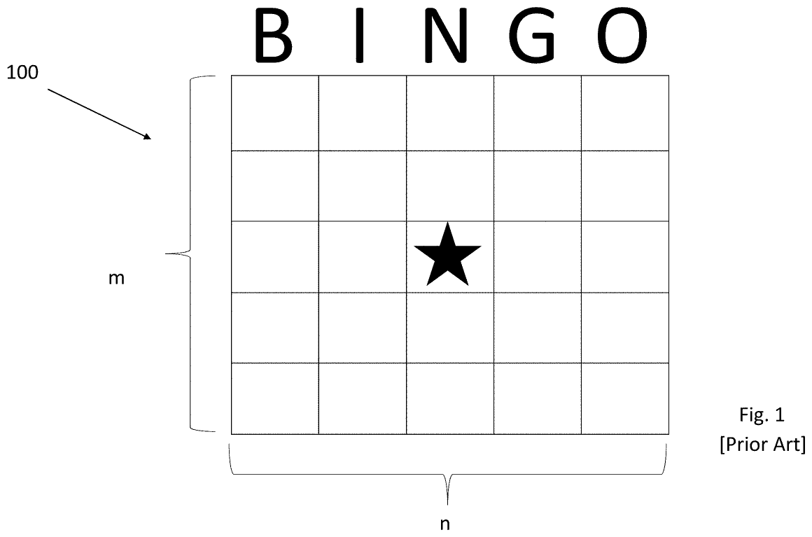

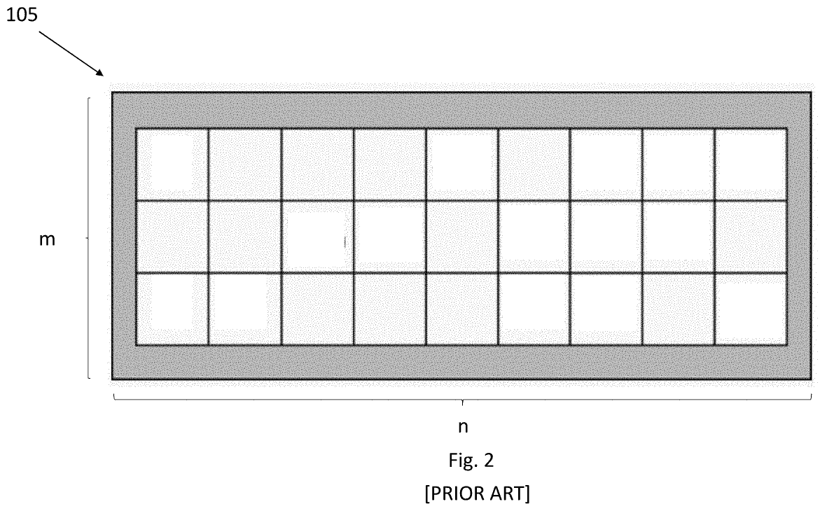

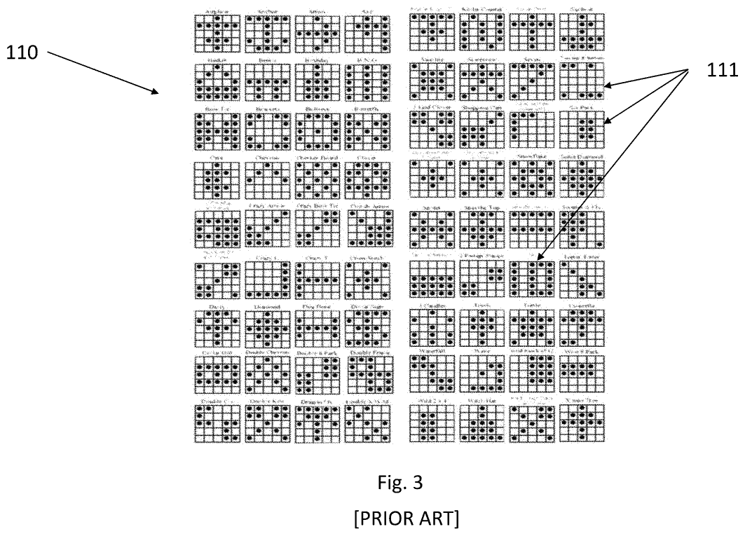

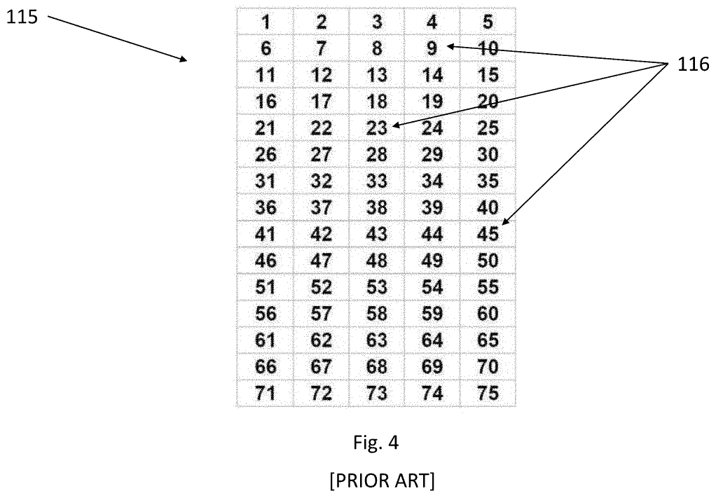

Before any game begins, the game operator must create a unique winning pattern for that game. As shown in FIG. 1, an American bingo card 100 utilizes spaces forming 5×5 matrix. FIG. 2 shows an alternative bingo card 105 utilizing spaces forming a 3×9 matrix. Those skilled in the art will recognize that there are thousands of unique patterns that can be created using the American bingo card as well as alternative bingo cards. FIG. 3 shows a chart 110 detailing certain, but not all, conceivable winning bingo patterns 111 and FIG. 4 shows a chart 115 depicting the bingo numbers 116 associated with American bingo. Alternatively, other numbers, or more or less than 75 numbers may be used with the 5×5 matrix as well as any other conceivable bingo card matrix.

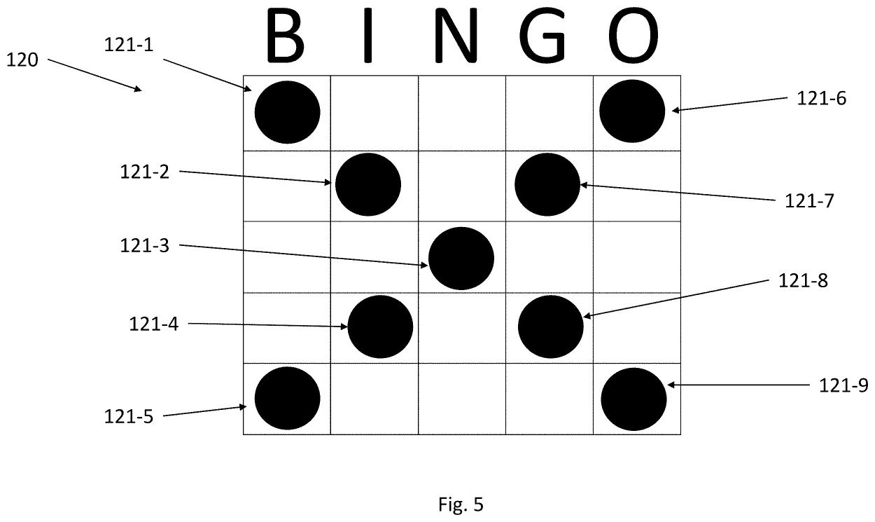

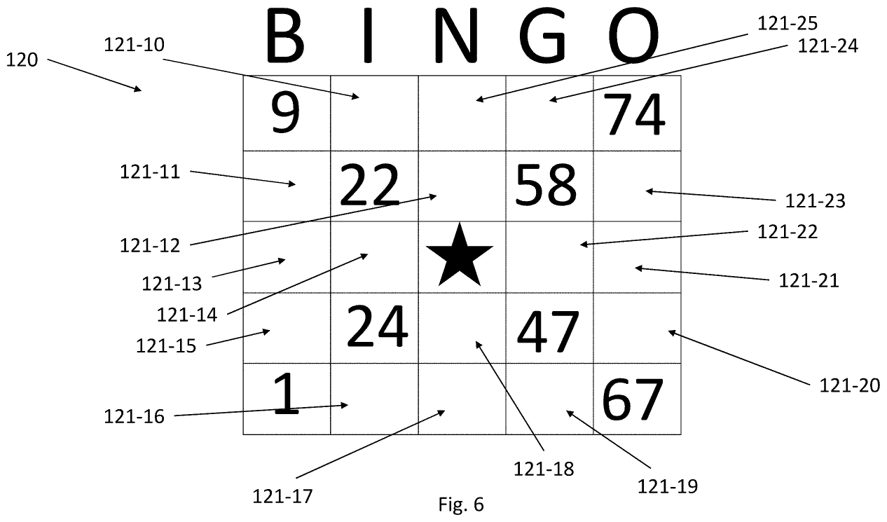

FIG. 5 shows a bingo card 120 with an X-shaped winning bingo pattern identified. As shown, the X-shaped winning bingo pattern requires a player to match numbers on eight spaces, namely spaces 121-1, 121-2 and 121-4 through 121-9 (121-3 is the free space so it need not be matched during play), to form the X-shaped winning bingo pattern. As shown in FIG. 6, with the X-shaped winning bingo pattern, there are sixteen spaces 121-10 through 121-25 not associated with the spaces forming the X-shaped winning bingo pattern.

Once the winning bingo pattern or bingo patterns are determined, players select their bingo numbers associated with the specific winning bingo pattern. Players select a number of bingo numbers commensurate with the number of bingo spaces forming the winning bingo pattern. With an American bingo card, a winning bingo pattern may comprise from two to twenty-four (i.e., coverall) bingo numbers. With reference to FIG. 5, bingo numbers on eight spaces need to be matched to achieve the X-shaped winning bingo pattern.

Given the X-shaped winning bingo pattern, players select eight numbers. With the American bingo card, players need to select two numbers from each of the “B” column (1-15), “I” column (16-30), “G” column (31-45) and “O” column (46-75). For alternative bingo games, columns or rows may not have any such restrictions such that players may select any number from the entire pool of numbers without regards to the location on the bingo card.

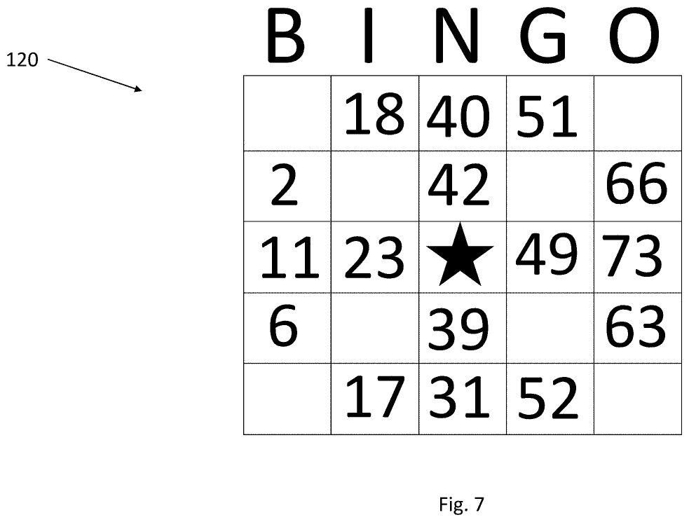

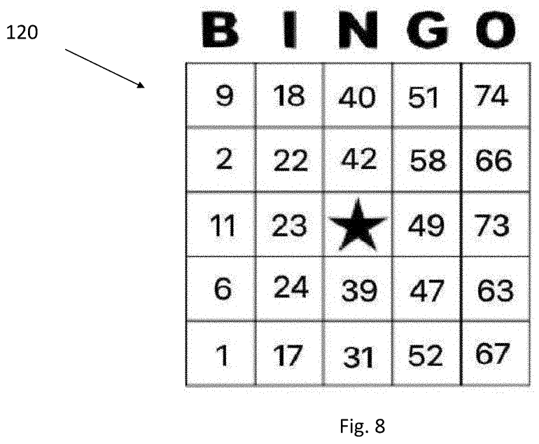

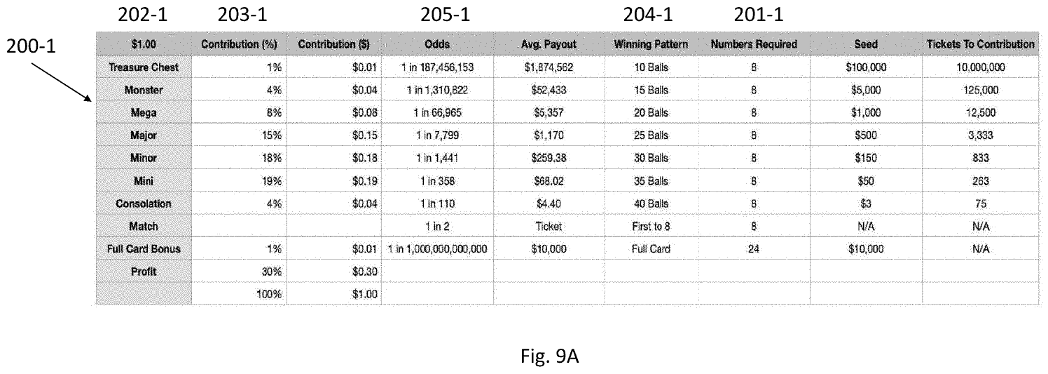

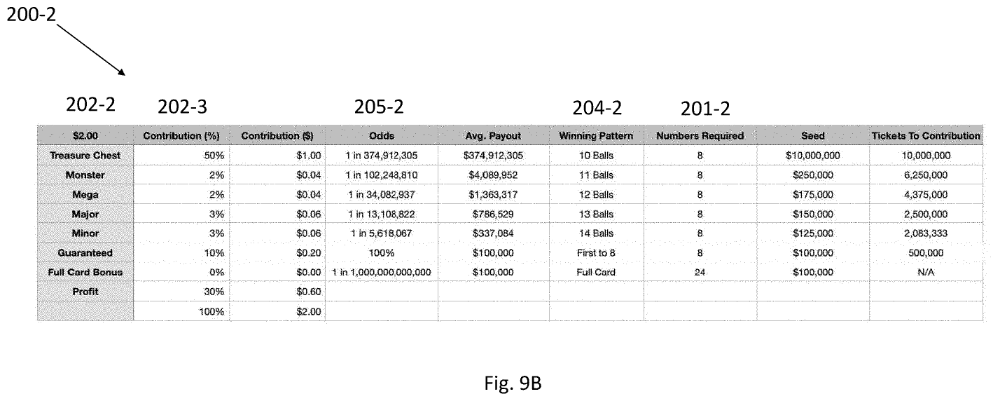

Once the player selects the two numbers from each of the “B” column (1-15), “I” column (16-30), “G” column (31-45) and “O” column (46-75), the system randomly assigns the player-selected numbers to the bingo spaces 121-1, 121-2 and 121-4 through 121-9 on the bingo card. Depending on the bingo card, the assignment of the player-selected numbers to the winning bingo pattern on the bingo card may also be quasi random. FIG. 6 shows the player-selected numbers 1, 9, 22, 24, 47, 58, 67 and 74 randomly assigned to form the X-shaped winning bingo pattern on the player's bingo card 120. Once the player-selected numbers are selected and assigned, the system, as shown in FIG. 7, randomly selects bingo numbers for the sixteen spaces 121-10 through 121-25 not associated with the spaces forming the X-shaped winning bingo pattern. The sixteen numbers are selected from the total pool of numbers (see FIG. 4) excluding the eight bingo numbers selected by the player. FIG. 7 shows the sixteen bingo numbers on the bingo card 120. FIG. 8 shows the bingo card 120 with all numbers depicted therein.

As per with conventional bingo, each player in the game competes with every other player in the game with the first to achieve the winning bingo pattern is declared the winner. The system is configured so that each bingo card is unique based first on the player-selected numbers and second based on each of the previous bingo cards generated. Since it is not possible to predetermine the combination of numbers that each player selects or the unique winning bingo pattern that is chosen by the game administrator, the system monitors the timestamp to the millisecond (or more often) when each of the players joins the game. Based on the precise timestamp, unique bingo cards are then generated one-by-one for each of the players competing in the game. In broadest terms, at step 1, the system randomly positions the player-selected numbers on the bingo card into the spaces forming the winning bingo pattern; at step 2, the system selects random bingo numbers for the other bingo card spaces to fill the bingo card and at step 3, the system randomly positions the system-selected numbers on the spaces not forming the winning bingo pattern.

For each bingo card after the first one generated, the system compares each new bingo card to each previously generated bingo card (based on timestamps) to ensure the new bingo card is not identical to any previously generated bingo card. If the new bingo card matches an existing bingo card, in one embodiment, the system randomly selects a new set of bingo numbers for the spaces not forming the winning bingo pattern. The system may use other solutions as well.

Unlike traditional lottery games that allow players to pick their own numbers, the number of bingo balls drawn is not fixed. Bingo balls are drawn until a winner is identified. With the large pool of bingo players, jackpots may reach amounts akin to typical lottery prizes. A large progressive jackpot may be associated with a player achieving the winning bingo pattern in a pre-established number of ball draws. If no player does so, a lessor prize may be awarded for a player achieving the winning bingo pattern after the pre-established number of ball draws.

In one embodiment, artificial intelligence is utilized to match two remote players to play an instant bingo game simultaneously. The artificial intelligence recognizes the timestamps of bingo cards and within a pre-established time period matches two players. If no two players are available during the pre-established time period, the system is configured to disregard the player-matching protocol and play continues against the system's proxy player through artificial intelligence.

s. Each table 200-1, 200-2 is based on a winning bingo pattern requiring eight numbers/spaces to achieve as set forth in columns 201-1, 201-2. A series of progressive branded jackpots, in this instance, Treasure Chest, Monster, Mega, Major, Minor, etc., are depicted in columns 202-1, 202-2. Each progressive jackpot is funded with a portion of bingo card fees as depicted in columns 203-1, 203-2. The odds of achieving the winning bingo pattern, based on a minimum number of ball draws depicted in columns 204-1, 204-2, is depicted in columns 205-1, 205-2.

As shown in table 200-1, the Treasure Chest (largest prize) is awarded to the first bingo card being marked with the 8-space winning bingo pattern within 10 number draws. If nobody wins the Treasure Chest, number draws continue until a bingo card is marked with the winning bingo pattern within the first 15 number draws (Monster), 20 number draws (Mega), 25 number draws (Major), 30 number draws (Minor) etc. In one embodiment, once a prize is won, the number draws cease. In other instances, the number draws may continue after a winning bingo card is identified to allow for more than one prize to be awarded.

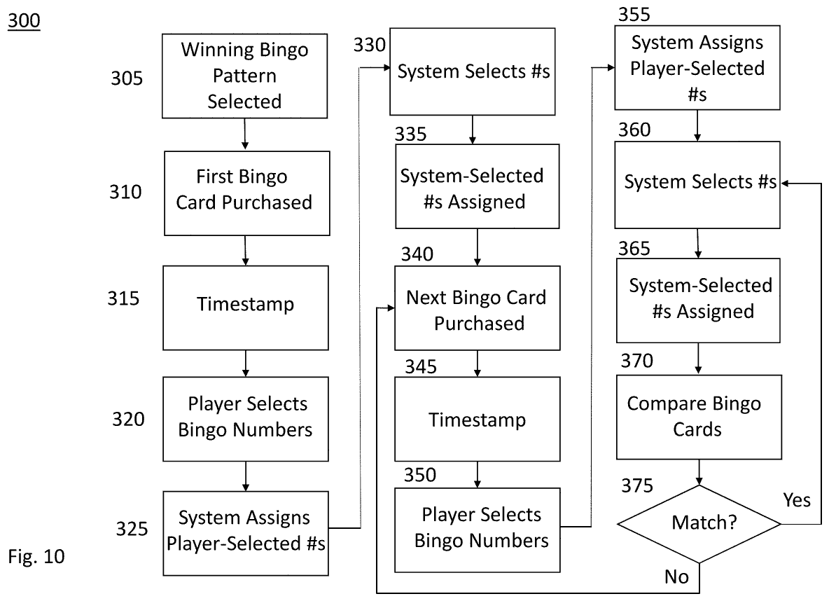

FIG. 10 shows a flow chart 300 detailing one methodology of conducting a bingo game according to the embodiments of the present invention. At 305, the system or operator establishes the winning bingo pattern. At 310, a first player purchases a bingo card. At 315, the system timestamps the purchase. At 320, the player selects a group of bingo numbers commensurate with the number of spaces forming the winning bingo pattern. In one embodiment, the system compares the player-selected bingo numbers with each previous group of player-selected bingo numbers and, if there is a match, prompts to the player to change one or more of his or her player-selected bingo numbers. Alternatively, the system permits multiple players to select the same bingo numbers and potentially split a prize. At 325, the system randomly assigns the player-selected numbers to the bingo card spaces forming the winning bingo pattern. At 330, the system randomly selects bingo numbers from the remaining pool of bingo numbers for the spaces not associated with the winning bingo pattern. At 335, the system randomly assigns the system-selected numbers to the bingo card spaces not forming the winning bingo pattern. At 340, a next player buys a bingo card. At 345, the system timestamps the purchase. At 350, the player selects a group of bingo numbers commensurate with the number of spaces forming the winning bingo pattern. At 355, the system randomly assigns the player-selected numbers to the bingo card spaces forming the winning bingo pattern. At 360, the system randomly selects bingo numbers from the remaining pool of bingo numbers for the spaces not associated with the winning bingo pattern. At 365, the system randomly assigns the system-selected numbers to the bingo card spaces not forming the winning bingo pattern. At 370, the system compares the bingo card to all previously generated bingo cards to one another. At 375, it is determined if the current bingo card matches any previously generated bingo card. If so, the chart 300 loops back to 360 and re-selects and assigns bingo numbers to the bingo card spaces not forming the winning bingo pattern. This is repeated until no match occurs. If no match, the chart loops back to 340. This process continues until a ball draw begins and then repeats until a next ball draw.

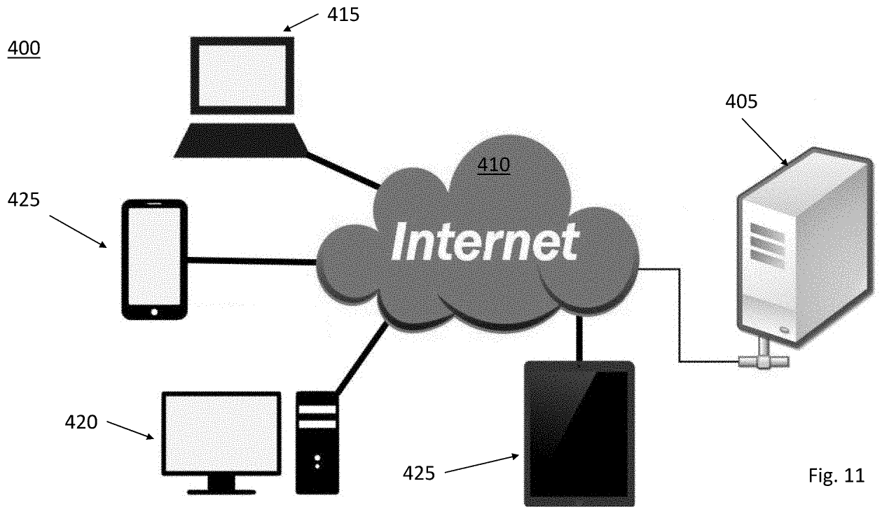

The embodiments of the present invention facilitate large prizes and can be played by an unlimited number of players. FIG. 11 shows a basic schematic 400 of the bingo system comprising a central server/computer 405 incorporating one or more processors running executable instructions to select a winning bingo pattern, accept player-selected bingo numbers, assign said player-selected bingo numbers to the bingo card spaces forming the winning bingo pattern, select bingo numbers for the bingo spaces not forming part of the winning bingo pattern, randomly assign the system-selected bingo numbers to the bingo card spaces not forming part of the winning bingo pattern, compare each new bingo card to previously generated bingo cards for matches, modify an identically matched bingo card to eliminate said identical match; conduct a number draw; and award a prize to at least a person holding said bingo card to first be marked with said winning bingo pattern. Players may access the game via the Internet 410 using laptops 415, desktops 420 or smart devices 425.

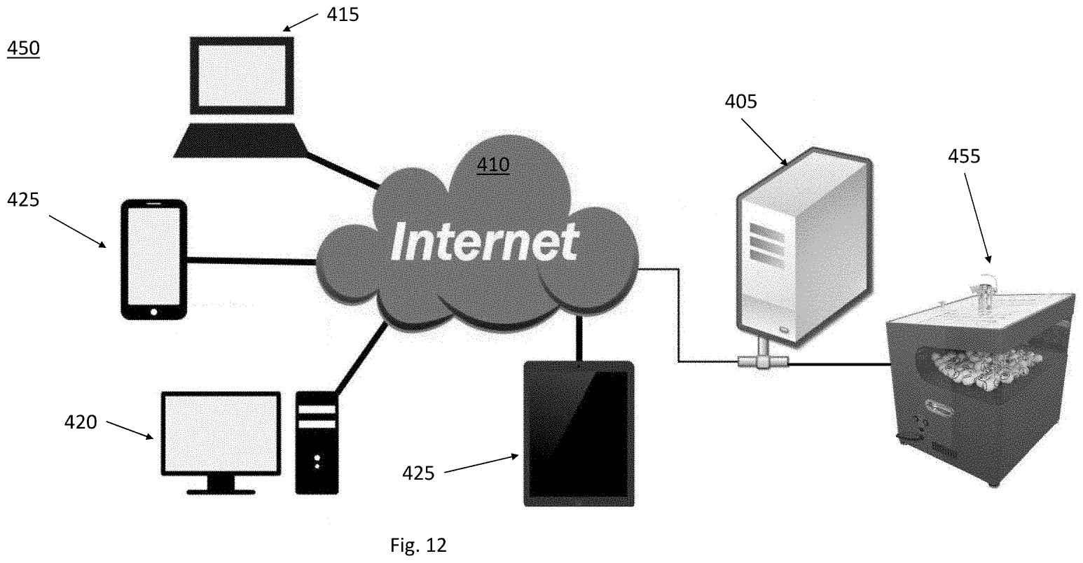

The bingo system may also use mechanical means, such as a ball blower, to generate the ball draws. FIG. 12 shows an alternative bingo system 450 using a ball blower 455 having an output connected to the server/computer 405. In this case, the ball blower, rather than the software-driven processor and random number generator, randomly draw the bingo numbers.

A bingo ball draw, ball draw, number draw or draw as used herein means any method, software and/or hardware used to randomly select numbers and/or symbols from a pool or numbers and/or symbols.

Although various embodiments of the claimed invention have been described above with a certain degree of particularity, or regarding one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of certain embodiments and not limiting. Changes in detail or structure may be made without departing from the basic elements of the invention as defined in the following claims.

We claim:

1. A system for conducting a bingo-style game, comprising:
at least one server including a processor running executable instructions to:
accept player-selected bingo numbers from a pool of bingo numbers wherein a number of said player-selected bingo numbers corresponds with a number of bingo card spaces forming a pre-established winning bingo pattern on an m×n matrix bingo card;
assign said player-selected bingo numbers to the bingo card spaces forming said winning bingo pattern;
select bingo numbers for the bingo card spaces not forming part of said winning bingo pattern;
assign said system-selected numbers to bingo card spaces not forming part of said winning bingo pattern;
compare each new bingo card to previously generated bingo cards for identical matches;
modify any identically matched bingo card to eliminate said identical match;
conduct a number draw; and
award a prize to at least a person holding said bingo card to first be marked with said winning bingo pattern.

2. The system according to claim 1 further comprising said processor running executable instructions to: timestamp formation of each bingo card.

3. The system according to claim 1 further comprising said processor running executable instructions to: modify any identically matched bingo card to eliminate said identical match by assigning new system-selected numbers to bingo card spaces not forming part of said winning bingo pattern.

4. The system according to claim 1 wherein said m×n matrix is a 5×5 matrix and said pool of bingo numbers comprises 75 bingo numbers numbered 1-75.

5. The system according to claim 1 further comprising said processor running executable instructions to:
randomly assign said player-selected bingo numbers to the bingo card spaces forming said winning bingo pattern;
randomly select bingo numbers for the bingo card spaces not forming part of said winning bingo pattern; and/or
randomly assign said system-selected numbers to bingo card spaces not forming part of said winning bingo pattern.

6. The system of claim 1 further comprising said processor running executable instructions to: conduct a number draw using a mechanical device and/or software-based random number generator.

7. A system for conducting a bingo-style game, comprising:
a bingo card comprising an m×n matrix of spaces;
at least one server including a processor running executable instructions to:
select a winning bingo pattern from a pool of winning bingo patterns;
accept player-selected bingo numbers from a pool of bingo numbers wherein a number of said player-selected numbers corresponds with a number of bingo card spaces forming said winning bingo pattern;
assign said player-selected bingo numbers to the bingo card spaces forming said winning bingo pattern;
select bingo numbers for the bingo card spaces not forming part of said winning bingo pattern;
assign said system-selected numbers to bingo card spaces not forming part of said winning bingo pattern,
compare each new bingo card to previously generated bingo cards for identical matches;
modify any identically matched bingo card to eliminate said identical match;
timestamp each completed bingo card
conduct a number draw;
award a prize to at least a person holding said bingo card to first be marked with said winning bingo pattern.

8. The system according to claim 7 further comprising said processor running executable instructions to: modify any identically matched bingo card to eliminate said identical match by assigning new system-selected numbers to bingo card spaces not forming part of said winning bingo pattern.

9. The system according to claim 7 wherein said m×n matrix is a 5×5 matrix and said pool of bingo numbers comprises 75 bingo numbers numbered 1-75.

10. The system according to claim 7 further comprising said processor running executable instructions to:
randomly assign said player-selected bingo numbers to the bingo card spaces forming said winning bingo pattern;
randomly select bingo numbers for the bingo card spaces not forming part of said winning bingo pattern; and/or
randomly assign said system-selected numbers to bingo card spaces not forming part of said winning bingo pattern.

11. The system of claim 10 further comprising said processor running executable instructions to: conduct a number draw using a mechanical device and/or software-based random number generator.

12. A method of conducting a bingo-style game comprising:
identifying a winning bingo pattern on a m×n matrix bingo card;
accepting player-selected bingo numbers from a pool of bingo numbers wherein a number of said player-selected bingo numbers corresponds with a number of bingo card spaces forming said winning bingo pattern;
assigning said player-selected bingo numbers to the bingo card spaces forming said winning bingo pattern;
selecting bingo numbers for the bingo card spaces not forming part of said winning bingo pattern;
assigning said system-selected numbers to bingo card spaces not forming part of said winning bingo pattern,
comparing each new bingo card to previously generated bingo cards for identical matches;
modifying any identically matched bingo card to eliminate said identical match;
conducting a number draw; and
awarding a prize to at least a person holding said bingo card to first be marked with said winning bingo pattern.

13. The method according to claim 12 further comprising timestamping formation of each bingo card.

14. The method according to claim 12 further comprising modifying any identically matched bingo card to eliminate said identical match by assigning new system-selected numbers to bingo card spaces not forming part of said winning bingo pattern.

15. The method according to claim 12 wherein said m×n matrix is a 5×5 matrix and said pool of bingo numbers comprises 75 bingo numbers numbered 1-75.

16. The method according to claim 12 further comprising:
randomly assigning said player-selected bingo numbers to the bingo card spaces forming said winning bingo pattern;
randomly selecting bingo numbers for the bingo card spaces not forming part of said winning bingo pattern; and/or
randomly assigning said system-selected numbers to bingo card spaces not forming part of said winning bingo pattern.

17. The method of claim 16 further comprising conducting a number draw using a mechanical device and/or software-based random number generator.
